(19) United States
(12) Patent Application Publication
(10) Pub. No.: US 2025/0155548 A1
(43) Pub. Date: May 15, 2025

(54) RADAR ON-CHIP ANTANA APPARATUS

(71) Applicants: HYUNDAI MOTOR COMPANY, Seoul (KR); KIA CORPORATION, Seoul (KR); Korea University Research and Business Foundation, Seoul (KR)

(72) Inventors: Sang Hyeok Yang, Hwaseong-si (KR); Hyun Soo Kim, Hwaseong-si (KR); Jae Sung Rieh, Seoul (KR); Do Yoon Kim, Hwaseong-si (KR); Jung Hwan Yoo, Suwon-si (KR)

(73) Assignees: HYUNDAI MOTOR COMPANY, Seoul (KR); KIA CORPORATION, Seoul (KR); Korea University Research and Business Foundation, Seoul (KR)

(21) Appl. No.: 18/939,070

(22) Filed: Nov. 6, 2024

(30) Foreign Application Priority Data
Nov. 9, 2023 (KR) 10-2023-0154831

(51) Int. Cl. G01S 7/03; G01S 7/02

(52) U.S. Cl. CPC G01S 7/032; G01S 7/028

(57) ABSTRACT

A radar on-chip antenna apparatus includes a transceiving chip provided in a substrate to process a radar signal; a transmitting antenna and a receiving antenna built into the transceiving chip and configured to transmit the radar signal and to receive the radar signal, respectively; and a first lens and a second lens disposed on a rear surface of the transceiving chip.

### CROSS-REFERENCE TO RELATED APPLICATION

This application claims priority to and the benefit of Korean Patent Application No. 10-2023-0154831, filed in the Korean Intellectual Property Office on Nov. 9, 2023, the entire contents of which are incorporated herein by reference.

### TECHNICAL FIELD

The present disclosure relates to a radar on-chip antenna apparatus and, more particularly, to a rear radial on-chip antenna.

### BACKGROUND

Among radio frequency (RF) signal bands, a terahertz band has a broadband characteristic and is therefore considered a next-generation radio frequency resource. In order to configure such a broadband system, an output antenna of a transmitting terminal and an input antenna of a receiving terminal must also have the broadband characteristic.

A semiconductor chip-based transceiving terminal using tens of GHz bands mainly use a method of connecting input and output portions with an antenna of a PCB through wire bonding. However, in frequency bands above 100 GHZ, there is a problem of large power loss in wire bonding.

Accordingly, an antenna can be integrated inside a chip to eliminate a need for wire bonding between the chip and the board (PCB), and thus research is being actively conducted on how to use an on-chip antenna with less risk of power loss.

The on-chip antenna may be classified into a front radiating form and a back radiating form. In terms of radiation efficiency, the front radiating form with fewer obstructions may be advantageous but has disadvantage of having a relatively small frequency bandwidth during front radiation.

Accordingly, a rear radiating antenna with a wide bandwidth is more suitable for a broadband system. However, for a rear radiating antenna, in terms of an internal cross-sectional structure of a transceiving chip, a radiation pattern is not properly formed due to interference with a rear silicon substrate inside the transceiving chip.

In general, efficiency and directionality of the on-chip antenna may be increased by providing a silicon lens outside a rear surface of the chip. In the instant case, the silicone lens is not attached and is spaced at a certain distance, and thus directivity of transmitted and received signal beams is low. In the case of general radar transmitting and receiving terminals, a distance between transmitting and receiving antennas is large, and thus when one silicone lens is attached, the transmitted and received signal beams may come out in different directions.

Accordingly, structural design for antennas and lenses, which have a wide frequency bandwidth and facilitate control of transmission and reception directions is desired.

### SUMMARY

The present disclosure provides a radar on-chip antenna apparatus including a dual silicon lens attachment structure.

The present disclosure also provides a radar on-chip antenna apparatus configured for increasing efficiency of detection of received signals by not only securing a wide frequency band using a rear on-chip antenna, but also matching transmission and reception directions of signals radiated through a dual silicon lens structure.

The technical objects of the present disclosure are not limited to the objects mentioned above, and other technical objects not mentioned may be clearly understood by those having ordinary skill in the art from the description of the claims.

In an embodiment of the present disclosure, a radar on-chip antenna apparatus includes: a transceiving chip disposed in a substrate to process a radar signal. The radar on-chip antenna apparatus also includes a transmitting antenna and a receiving antenna built into the transceiving chip and configured to transmit the radar signal and to receive the radar signal, respectively. The radar on-chip antenna apparatus also includes a first lens and a second lens disposed on a rear surface of the transceiving chip.

In an embodiment of the present disclosure, the rear surface of the transceiving chip and the first lens and the second lens may be attached to each other through direct contact.

In an embodiment of the present disclosure, the first lens may be disposed to be aligned with the transmitting antenna, and the second lens may be disposed to be aligned with the receiving antenna.

In an embodiment of the present disclosure, the transmitting antenna and the receiving antenna may be of a rear-radiating type.

In an embodiment of the present disclosure, the transmitting antenna and the receiving antenna may be disposed at a portion in the transceiving chip where interference therebetween is minimal.

In an embodiment of the present disclosure, the transmitting antenna and the receiving antenna may be disposed at opposite ends of the transceiving chip.

In an embodiment of the present disclosure, the first lens and the second lens may be formed of silicon.

In an embodiment of the present disclosure, the first lens and the second lens may be attached to the rear surface of the transceiving chip using epoxy.

In an embodiment of the present disclosure, a hole may be formed in the substrate, and the transceiving chip may be inserted into the hole.

In an embodiment of the present disclosure, the first lens and the second lens may be configured in a hemisphere form.

An embodiment of the present disclosure provides a radar on-chip antenna apparatus including a transceiving chip disposed in a substrate to process a radar signal. The radar on-chip antenna apparatus also includes a transmitting antenna and a receiving antenna built into the transceiving chip and configured to transmit the radar signal and to receive the radar signal, respectively. The radar on-chip antenna apparatus also includes a lens portion attached to a rear surface of the transceiving chip.

In an embodiment of the present disclosure, the lens portion may include a first lens and a second lens disposed apart from each other.

In an embodiment of the present disclosure, the first lens may be disposed to be aligned with the transmitting antenna, and the second lens may be disposed to be aligned with the receiving antenna.

In an embodiment of the present disclosure, the transmitting antenna and the receiving antenna may be of a rear-radiating type.

In an embodiment of the present disclosure, the transmitting antenna and the receiving antenna may be disposed at a portion in the transceiving chip where interference therebetween is minimal.

In an embodiment of the present disclosure, the transmitting antenna and the receiving antenna may be disposed at opposite ends of the transceiving chip.

In an embodiment of the present disclosure, the first lens and the second lens may be formed of silicon.

In an embodiment of the present disclosure, the first lens and the second lens may be attached to the rear surface of the transceiving chip using epoxy.

In an embodiment of the present disclosure, a hole may be formed in the substrate, and the transceiving chip may be inserted into the hole.

In an embodiment of the present disclosure, a rear outer side of the transceiving chip and the first lens and the second lens may be attached to each other through direct contact.

In an embodiment of the present disclosure, the first lens and the second lens may be configured in a hemisphere form.

According to the present technique, it may be possible to increase efficiency of detection of received signals by not only securing a wide frequency band using a rear on-chip antenna, but also matching transmission and reception directions of signals radiated through a dual silicon lens structure.

According to the present technique, it may be possible to prevent power loss due to wire bonding by applying a rear on-chip antenna structure to a broadband radar system and not only to solve a low bandwidth problem but also to adjust directionality of transmitted and received signals.

Furthermore, various effects which may be directly or indirectly identified through the present specification may be provided.

### BRIEF DESCRIPTION OF THE DRAWINGS

FIG. 1 illustrates a structure of an example radar on-chip antenna apparatus including a dual silicon lens.

FIG. 2 illustrates a radiation tendency of an example radar on-chip antenna with a single silicon lens.

FIG. 3 illustrates a radiation tendency of an example radar on-chip antenna with a dual silicon lens.

FIG. 4 illustrates a perspective view of an example structure in which a dual silicon lens of a radar on-chip antenna apparatus is attached to a substrate.

FIG. 5 illustrates a cross-sectional view of an example structure in which a dual silicon lens of a radar on-chip antenna apparatus is attached to a substrate.

FIG. 6 illustrates an example of a transceiving terminal chip of a radar on-chip antenna apparatus.

FIG. 7 illustrates a bottom view of a substrate of an example radar on-chip antenna apparatus.

FIG. 8 illustrates an example of verifying a maximum operating distance of a radar on-chip antenna apparatus.

The drawings described herein are for illustration purposes only and are not intended to limit the scope of the present disclosure in any way.

### DETAILED DESCRIPTION

Hereinafter, some embodiments of the present disclosure are described in detail with reference to drawings. It should be noted that in adding reference numerals to constituent elements of each drawing, the same and equivalent constituent elements include the same reference numerals as possible even though the constituent elements are indicated on different drawings. In describing an embodiment of the present disclosure, when it is determined that a detailed description of the well-known configuration or function associated with the embodiment of the present disclosure may obscure the gist of the present disclosure, the detailed description has been omitted.

In describing constituent elements according to an embodiment of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms include the same meanings as those, which are generally understood by those having ordinary skill in the technical field of the disclosure to which an embodiment of the present disclosure pertains (hereinafter “those having ordinary skill in the art”) unless the terms are differently defined. Terms defined in a generally used dictionary shall be construed to have meanings matching those in the context of a related art and shall not be construed to have idealized or excessively formal meanings unless the terms are clearly defined in the present disclosure. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

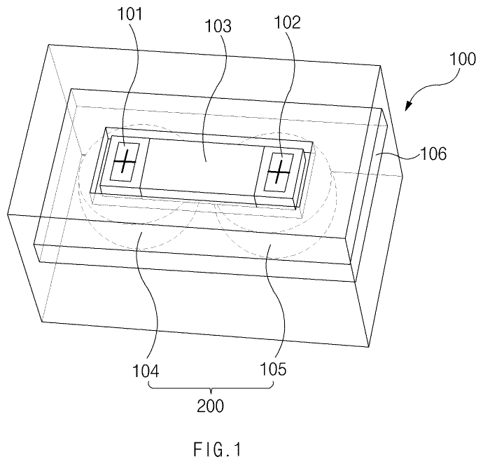

Hereinafter, various embodiments of the present disclosure have been described in detail with reference to FIG. 1-FIG. 8.

FIG. 1 illustrates a structure of an example radar on-chip antenna apparatus including a dual silicon lens.

Referring to FIG. 1, the radar on-chip antenna apparatus 100 according to an embodiment of the present disclosure may include an output antenna 101 of a transmitting terminal and an input antenna 102 of a receiving terminal. The output antenna 101 and the input antenna 102 have a broadband characteristic.

In the instant case, the output antenna 101 and the input antenna 102 may be integrated inside a transceiving chip 103 and are therefore called on-chip antennas. Because the output antenna 101 and the input antenna 102, which have the broadband characteristic, are integrated inside the transceiving chip 103, wire bonding may not be required between the transceiving chip 103 and a substrate 106, and thus power loss due to wire bonding may be prevented.

This radar on-chip antenna apparatus 100 may be classified into a front radiating form and a rear radiating form, and in the present disclosure, a rear-radiating radar on-chip antenna structure with a relatively large frequency bandwidth is disclosed. Among the on-chip antennas, a patch antenna is an antenna configured to radiate to a front surface of the chip. Among the on-chip antennas, antennas that radiate to a rear surface may include, for example, a dipole antenna, a ring antenna, and a slot antenna.

Such a rear-radiating radar on-chip antenna may easily solve a bandwidth problem compared to the front-radiating antenna. A body (silicon substrate) within the transceiving chip 103 may be positioned at the rear surface, so a directivity of a radar signal may be lowered due to the body (silicon substrate) within the transceiving chip 103 so that radiation patterns of transmitted and received beams may differ from the simulation. Accordingly, it may be necessary to increase directivity by attaching a silicon lens to an outside of the transceiving chip 103.

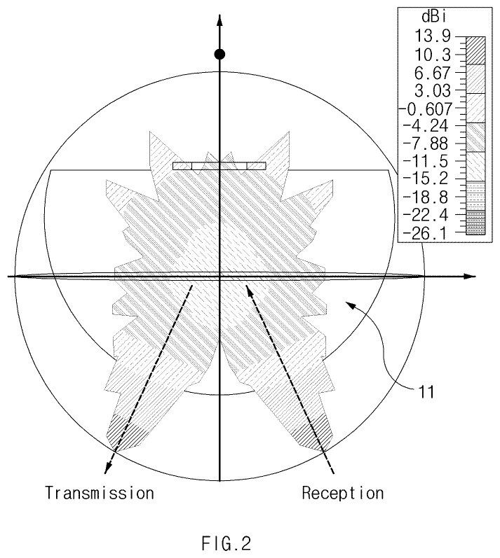

However, because the silicon lens has a very high directivity, actual measurements of radar on-chip antennas may require considerable attention to the alignment of the setup between the silicon lens and the antenna. Specifically, in response to applying a single silicone lens, in the case of a basic bistatic radar transceiving terminal, a transmitting terminal antenna 101 and a receiving terminal antenna 102 may be provided, but it may be difficult to align the two antennas 101 and 102 so that the two antennas 101 and 102 may be positioned in an exact center of the single silicon lens. Although the two antennas 101 and 102 are aligned to be positioned in the exact center of the single silicon lens, in the case of actual radiation patterns, a reception pattern or transmission pattern may be distorted. FIG. 2 illustrates a radiation tendency of an example radar on-chip antenna with a single silicon lens. Referring to FIG. 2, it may be seen that be seen that directions of a transmitted beam and a received beam are different in response to a case where the single silicon lens 11 is used. In other words, it may be seen that actual measurement of the radar on-chip antenna apparatus 100 is difficult to predict, and thus it is difficult to set up the single silicon lens 11 for alignment of the transmitted and received beams.

Accordingly, in the present disclosure, as illustrated in FIG. 1, dual silicon lenses 104 and 105 are provided between the transmitting antenna 101 and the receiving antenna 102. In the instant case, the transmitting antenna 101 and the receiving antenna 102 may be integrated into the transceiving chip 103, and the transceiving chip 103 may be inserted into the substrate 106. Accordingly, the transceiving chip 103 including the transmitting antenna 101 and the receiving antenna 102 and the substrate 106 may be implemented as a single layer. The transmitting antenna 101 may be configured as a transmitting dipole antenna, and the receiving antenna 102 may be configured as a receiving dipole antenna.

In the instant case, the silicon lenses 104 and 105 may be attached to a rear surface of the transceiving chip 103, and the silicon lenses 104 and 105 may each include an ultra-small silicon lens. Accordingly, signal loss or loss of beam pattern directionality may be minimized by attaching the rear surface of the transceiving chip 103 and the silicon lenses 104 and 105 directly against each other. Furthermore, the silicon lenses 104 and 105 may have a shape to maximize directivity of radar signals, and the present disclosure discloses an example implemented in the form of a hemisphere. However, it is not limited thereto, and it may be implemented in various forms that can improve the directivity of the radar signals.

The silicon lens 104 may be positioned at a lower end of the transmitting terminal antenna 101, and the silicon lens 105 may be positioned at a lower end of the receiving terminal antenna 102 to minimize distortion of the radiation pattern and thereby minimize inconsistency between patterns of the transmitted beam and the received beam.

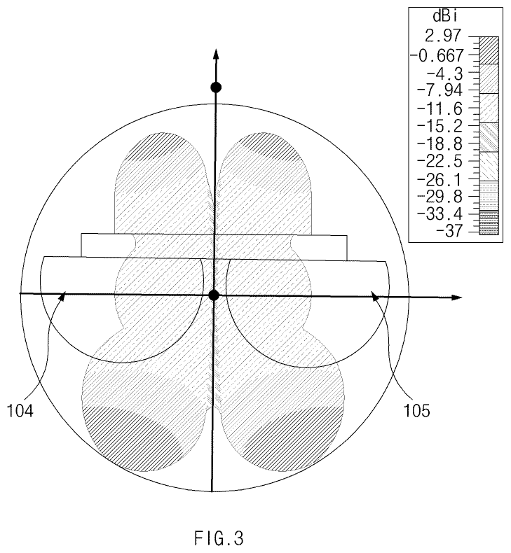

FIG. 3 illustrates a radiation tendency of an example radar on-chip antenna with a dual silicon lens. Referring to FIG. 3, a tendency for the radar beam to radiate evenly in all directions from the rear direction of the transceiving chip 103 of the radar on-chip antenna apparatus 100 of the present disclosure may be checked.

Accordingly, according to the present disclosure, directions of the patterns of the transmitted beam and the received beam may be matched by applying silicon lenses 104 and 105 to the transmitting terminal antenna 101 and the receiving terminal antenna 102, respectively.

In the instant case, the transmitting terminal antenna 101 and the receiving terminal antenna 102 may be positioned at a position to minimize interference with each other in a case of being integrated into the transceiving chip 103. FIG. 1 of the present disclosure illustrates an example in which the transmitting terminal antenna 101 and the receiving terminal antenna 102 are positioned at opposite ends of the transceiving chip 103. However, the present disclosure is not limited thereto, and the transmitting terminal antenna 101 and the receiving terminal antenna 102 may be positioned anywhere where a sufficient distance is secured to minimize interference between the transmitting terminal antenna 101 and the receiving terminal antenna 102. Accordingly, the transmitting terminal antenna 101 and the receiving terminal antenna 102 may be built in a position where interference between the transmitting terminal antenna 101 and the receiving terminal antenna 102 is minimized based on experimental values in advance.

Thus, in the present disclosure, it may be possible to increase efficiency of detection of received signals by not only securing a wide frequency band using a rear on-chip antenna, but also matching transmission and reception directions of signals radiated through a dual silicon lens structure.

Accordingly, according to the present disclosure, it may be possible to solve problems with bandwidth reduction and signal loss, which occur as a frequency increases in a field of radio frequency (RF) application.

The transceiving chip 103 may be implemented as a CMOS chip, which is an ultra-high frequency transceiving integrated circuit chip configured to generate and transmit electromagnetic waves and processes received signals. The transceiving chip 103 may be electrically connected to internal components of the radar on-chip antenna apparatus 100. The transceiving chip 103 may electrically control each component and may be an electrical circuit that executes software commands. Thus, the transceiving chip 103 may perform various data processing and calculations to be described below.

The transceiving chip 103 may be configured to process a signal transferred between components of the radar on-chip antenna apparatus 100 to perform overall control such that each component may perform its function normally. The transceiving chip 103 may be implemented in the form of hardware, software, or a combination of and software. For example, the transceiving chip 103 may be implemented as a microprocessor, but the present disclosure is not limited thereto.

The radar on-chip antenna apparatus 100 according to the present disclosure may be applied to a broadband system.

Furthermore, the radar on-chip antenna apparatus 100 may be applied to detect objects inside a vehicle. Accordingly, the radar on-chip antenna apparatus 100 may be implemented inside the vehicle or separately therefrom. In the instant case, the radar on-chip antenna apparatus 100 may be integrally formed with internal control units of the vehicle or may be implemented as a separate hardware device to be connected to control units of the vehicle by a connection means. For example, the radar on-chip antenna apparatus 100 may be implemented integrally with the vehicle. Alternatively, the radar on-chip antenna apparatus 100 may be implemented in a form that is installed or attached to the vehicle as a configuration separate from the vehicle. Alternatively, a part of the radar on-chip antenna apparatus 100 may be implemented integrally with the vehicle, and another part of the radar on-chip antenna apparatus 100 may be implemented in a form that is installed or attached to the vehicle as a configuration separate from the vehicle.

The radar on-chip antenna apparatus 100 according to an embodiment of the present disclosure may include a transceiving chip 103 provided in a substrate to process a radar signal, a transmitting antenna 101 configured to transmit a radar signal and a receiving antenna 102 configured to receive the radar signal, built into the transceiving chip 103, and silicon lenses 104 and 105 (first lens and second lens) provided on a rear surface of the transceiving chip 103.

The rear surface of the transceiving chip 103 and the silicon lenses 104 and 105 (the first lens and the second lens) may be attached directly against each other.

The silicon lens 104 (the first lens) may be positioned to be aligned with the transmitting antenna 101, and the silicon lens 105 (the second lens) may be positioned to be aligned with the receiving antenna 102.

The transmitting antenna 101 and the receiving antenna 102 may be rear-radiating types and may be spaced apart from each other and positioned at a portion in the transceiving chip 103 where interference therebetween is minimal, e.g., a predetermined value.

The transmitting antenna 101 and the receiving antenna 102 may be positioned at opposite ends of the transceiving chip 103, respectively. The silicon lenses 104 and 105 (the first lens and the second lens) may be formed of silicon.

The silicone lens 104 and 105 (the first lens and the second lens) may be attached to a rear surface of the transceiving chip 103 using epoxy, and a hole may be formed in the substrate 106, so that the transceiving chip 103 is in the hole.

The silicone lenses 104 and 105 (the first lens and the second lens) may be configured in a hemispherical shape.

The radar on-chip antenna apparatus 100 according to an embodiment of the present disclosure may include a transceiving chip 103 provided in a substrate to process a radar signal, a transmitting antenna 101 configured to transmit a radar signal and a receiving antenna 102 configured to receive the radar signal, built into the transceiving chip 103, and a lens portion 200 attached to a rear surface of the transceiving chip 103.

The lens portion 200 may include the silicon lenses 104 and 105 (the first lens and the second lens) positioned to be spaced apart from each other.

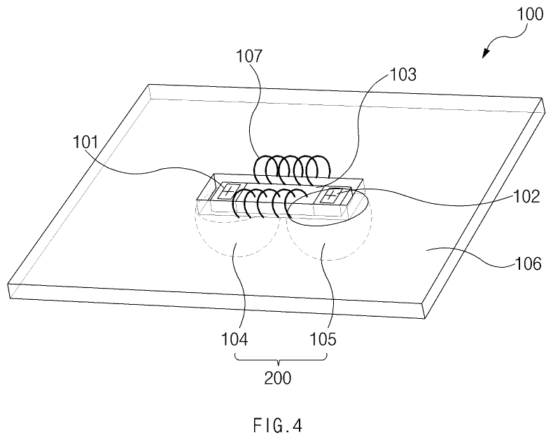

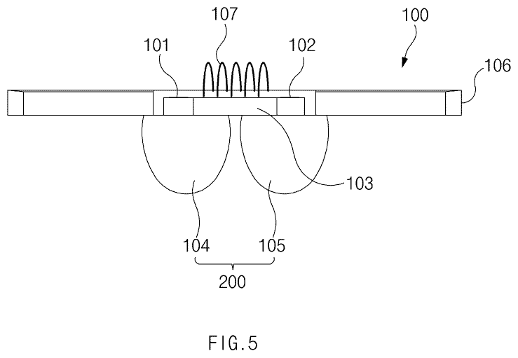

FIG. 4 illustrates a perspective view of an example structure in which a dual silicon lens of a radar on-chip antenna is attached to a substrate, and FIG. 5 illustrates a cross-sectional view of an example structure in which a dual silicon lens of a radar on-chip antenna is attached to a substrate.

Referring to FIG. 4, a wire bonding 107 is made on a front surface of the transceiving chip 103 for connection of electrical input and output signals.

Furthermore, the silicone lenses 104 and 105 may be attached to the rear surface of the transceiving chip 103, through which electromagnetic waves are radiated through the transmitting antenna 101 and the receiving antenna 102, using epoxy. In the instant case, epoxy has a dielectric constant similar to that of silicon (=11.8).

Electromagnetic wave signals may be radiated to the rear surface of the transceiving chip 103, and thus the transceiving chip 103 may be inserted into a hole in the substrate 106. As illustrated in FIG. 4, the transceiving chip 103 and the substrate 106 may be implemented as a single layer.

Referring to FIG. 5, the transceiving chip 103 may be inserted into the substrate 106, the transmitting antenna 101 and the receiving antenna 102 may be built into opposite ends of the transceiving chip 103, and the silicon lenses 104 and 105 may each be attached to the rear surface of the transceiving chip 103.

In the instant case, in a case where a substrate inside the transceiving chip 103 is thick and thus a radar signal is radiated to the rear surface thereof, the substrate inside the transceiving chip 103 may interfere with the radiation of the radar signal. Accordingly, directivity of the radar signal may be increased by providing the silicon lenses 104 and 105 on the rear surface of the transceiving chip 103. Furthermore, the silicon lenses 104 and 105 may be attached to the rear surface of the transceiving chip 103. Thus, a loss of the radar signal and a loss of directionality of the radar signal may be minimized, and directivity of the radar signal may be further increased. However, the attachment method of the silicon lenses 104 and 105 and the transceiving chip 103 may be modified according to a type and a shape of the substrate.

In the instant case, the silicon lens 104 may be arranged at a lower end of the transmitting antenna 101, and the silicon lens 105 may be arranged at a lower end of the receiving antenna 102.

Accordingly, the silicon lenses 104 and 105 may be arranged side by side on the transmitting antenna 101 and the receiving antenna 102, respectively, to increase directivity of signals radiated through the transmitting antenna 101 and directivity of signals received through the receiving antenna 102.

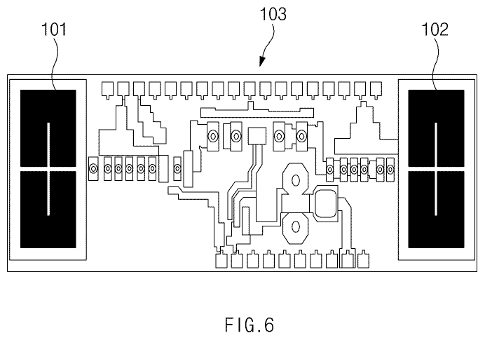

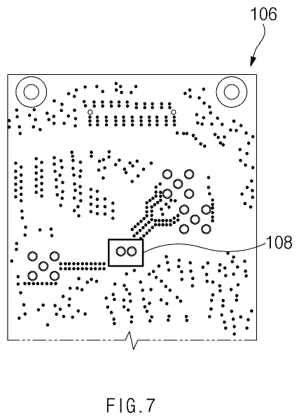

FIG. 6 illustrates an example of a transceiving terminal chip of the radar on-chip antenna apparatus 100, and FIG. 7 illustrates a bottom view of a substrate of an example radar on-chip antenna apparatus.

FIG. 6 illustrates examples of the transceiving chip 103 of the radar on-chip antenna apparatus 100 and the transmitting antenna 101 and the receiving antenna 102 integrated within the transceiving chip 103.

FIG. 7 illustrates examples of a rear surface of the substrate 106 of a radar on-chip antenna and attachment of two silicon lenses 108.

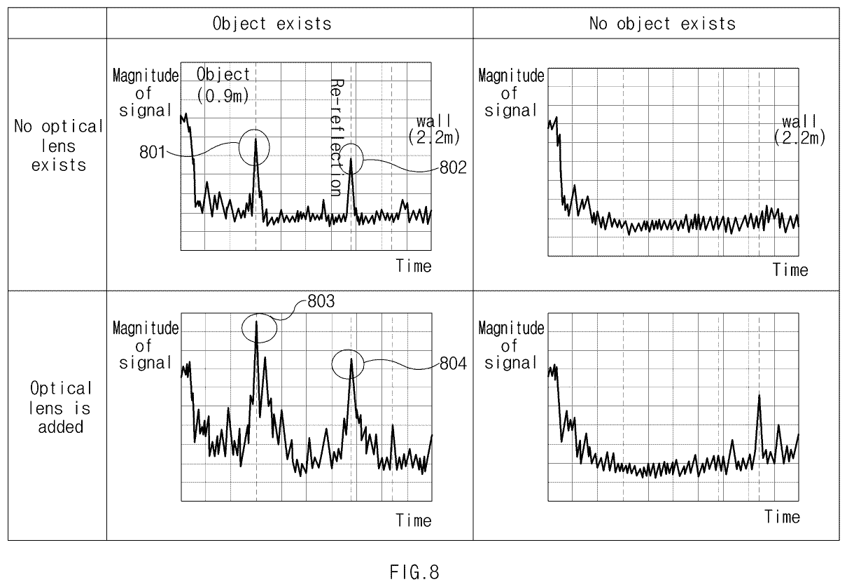

FIG. 8 illustrates an example of verifying a maximum operating distance of a radar on-chip antenna.

Referring to FIG. 8, an example of measuring a signal reflected from an actual object of the radar on-chip antenna apparatus 100 of the present disclosure may be seen.

In a case where an object exists between the radar on-chip antenna apparatus 100 and the wall, and a distance from the radar on-chip antenna apparatus 100 to the wall is 2.2 m and a distance to the object is 0.9 m, it may be seen that signal peaks 801 and 802 are detected for objects between the wall and the radar on-chip antenna apparatus 100. In a case where there is no object between the radar on-chip antenna apparatus 100 and the wall, there is no signal peak.

It may be seen that there is no problem in detecting objects even without adding an additional optical lens, and that the signals 803 and 804 become much larger by adding an additional optical lens.

Accordingly, according to the present disclosure, as a rear-radiating on-chip antenna, it may have less power loss than off-chip and may be used at a higher bandwidth than that of a front-radiating on-chip antenna.

Furthermore, according to the present disclosure, the transmitting antenna 101 and the receiving antenna 102 may be integrated at a position where interference between the transmitting antenna 101 and the receiving antenna 102 is minimized.

Furthermore, it may be possible to increase directivity of transmitted and received signals by attaching the dual silicon lenses 104 and 105 to the rear surface of the transceiving chip 103. Furthermore, the directivity of transmitted and received signals may be increased by arranging the dual silicon lenses 104 and 105 to be aligned with the transmitting antenna 101 and the receiving antenna 102, respectively.

In other words, according to the present disclosure, an efficiency of detection of received signals may be increased by matching transmission and reception directions of radiated signals in addition to securing a wide frequency band using the rear-radiating on-chip antenna.

The above description merely illustrates the technical idea of the present disclosure. Those having ordinary skill in the art to which the present disclosure pertains may make various modifications and variations without departing from the essential characteristics of the present disclosure.

Therefore, the embodiments disclosed in the present disclosure are not intended to limit the technical ideas of the present disclosure but to explain them, and the scope of the technical ideas of the present disclosure is not limited by these embodiments. The protection scope of the present disclosure should be interpreted by the claims below, and all technical ideas within the equivalent scope of the claims should be interpreted as being included in the scope of the present disclosure.

What is claimed is:

1. A radar on-chip antenna apparatus, comprising:
a transceiving chip disposed in a substrate to process a radar signal;
a transmitting antenna and a receiving antenna built into the transceiving chip and configured to transmit the radar signal and to receive the radar signal, respectively; and
a first lens and a second lens disposed on a rear surface of the transceiving chip.

2. The radar on-chip antenna apparatus of claim 1, wherein:
the rear surface of the transceiving chip and the first lens and the second lens are attached to each other through direct contact.

3. The radar on-chip antenna apparatus of claim 1, wherein:
the first lens is disposed to be aligned with the transmitting antenna, and
the second lens is disposed to be aligned with the receiving antenna.

4. The radar on-chip antenna apparatus of claim 1, wherein:
the transmitting antenna and the receiving antenna are of a rear-radiating type.

5. The radar on-chip antenna apparatus of claim 1, wherein
the transmitting antenna and the receiving antenna are disposed at a portion in the transceiving chip where interference therebetween is minimal.

6. The radar on-chip antenna apparatus of claim 1, wherein:
the transmitting antenna and the receiving antenna are disposed at opposite ends of the transceiving chip.

7. The radar on-chip antenna apparatus of claim 1, wherein:
the first lens and the second lens are formed of silicon.

8. The radar on-chip antenna apparatus of claim 1, wherein:
the first lens and the second lens are attached to the rear surface of the transceiving chip using epoxy.

9. The radar on-chip antenna apparatus of claim 1, wherein:
a hole is formed in the substrate, and the transceiving chip is inserted into the hole.

10. The radar on-chip antenna apparatus of claim 1, wherein:
the first lens and the second lens are configured in a hemisphere form.

11. A radar on-chip antenna apparatus comprising:
a transceiving chip disposed in a substrate to process a radar signal;
a transmitting antenna and a receiving antenna built into the transceiving chip and configured to transmit the radar signal and to receive the radar signal, respectively; and
a lens portion attached to a rear surface of the transceiving chip.

12. The radar on-chip antenna apparatus of claim 11, wherein:
the lens portion includes a first lens and a second lens disposed apart from each other.

13. The radar on-chip antenna apparatus of claim 12, wherein:
the first lens is disposed to be aligned with the transmitting antenna, and
the second lens is disposed to be aligned with the receiving antenna.

14. The radar on-chip antenna apparatus of claim 11, wherein:
the transmitting antenna and the receiving antenna are of a rear-radiating type.

15. The radar on-chip antenna apparatus of claim 11, wherein:
the transmitting antenna and the receiving antenna are disposed at a portion in the transceiving chip where interference therebetween is minimal.

16. The radar on-chip antenna apparatus of claim 11, wherein:
the transmitting antenna and the receiving antenna are disposed at opposite ends of the transceiving chip.

17. The radar on-chip antenna apparatus of claim 12, wherein:
the first lens and the second lens are formed of silicon, and
the first lens and the second lens are attached to the rear surface of the transceiving chip using epoxy.

18. The radar on-chip antenna apparatus of claim 11, wherein:
a hole is formed in the substrate, and
the transceiving chip is inserted into the hole.

19. The radar on-chip antenna apparatus of claim 12, wherein:
a rear outer side of the transceiving chip and the first lens and the second lens are attached to each other through direct contact.

20. The radar on-chip antenna apparatus of claim 12, wherein:
the first lens and the second lens are configured in a hemisphere form.
